(19) United States
(12) Patent Application Publication
(10) Pub. No.: US 2005/0285808 A1
(43) Pub. Date: Dec. 29, 2005

(54) Electrically controlled broadband group antenna, antenna element suitable for incorporation in such a group antenna, and antenna module comprising several antenna elements

(75) Inventor: Henrik Holter, Farsta (SE)

Correspondence Address: VENABLE LLP, P.O. BOX 34385, WASHINGTON, DC, 20045-9998, US

(73) Assignee: SAAB AB, Linkoping (SE)

(21) Appl. No.: 10/520,462

(22) PCT Filed: Jun. 25, 2003
(86) PCT No.: PCT/SE03/01098

§ 371 Date: Aug. 12, 2005

(30) Foreign Application Priority Data
Jul. 8, 2002 (SE) 0202123-6

(51) Int. Cl. H01Q 19/06

(52) U.S. Cl. 343/754

(57) ABSTRACT

An electrically controlled group antenna including an antenna element suitable for incorporation in such a group antenna and an antenna module including several such antenna elements. The antenna elements include a rotationally-symmetrical body tapering towards one end of the body. The rotationally-symmetrical body is provided with a metallic casing surface. Several antenna elements are arranged separately on a common earth plane. A broadband group antenna is achieved that, among other things, is simple in design and is easy to manufacture and repair.

The present invention relates to an electrically controlled broadband group antenna comprising a plurality of antenna elements arranged in a common plane Hand connected to a feeder unit. The invention also relates to an antenna element suitable for incorporation in an electrically controlled broadband group antenna, the antenna element comprising a rotationally-symmetrical body tapering towards one end. In addition, the invention relates to an antenna module with a plurality of such antenna elements. These group antennas preferably work with linear polarization or two orthogonal polarizations.

Electrically controlled broadband group antennas with an instantaneous bandwidth larger than one octave are a very important component in, among other things, military telecommunication systems and multifunction radar. There are currently only a few broadband antenna elements that are suitable for electrically controlled broadband group antennas. These antenna elements have a plurality of disadvantages.

A known type of broadband group antenna uses antenna elements that have the name “Tapered Slot”. See, in connection with this, IEEE Transactions on Antennas and Propagation, volume 48, no. 11, November 2000, pages 1707-1718, Experimental Results of 144-Element Dual-polarized Endfire Tapered-Slot Phased Arrays. In general, for known electrically controlled broadband group antennas, it is the case that the antenna elements are complicated and their production is difficult and therefore expensive. This applies in particular for group antennas with two orthogonal polarizations. In addition, it is often difficult to connect the antenna elements to an underlying microwave unit.

With regard to group antennas with “Tapered Slot” antenna elements, we can mention in particular difficulties in achieving electrical contact between adjacent antenna elements, which is important for the electrical function. This applies, in particular, for high frequencies, as the element distance is small. For example, the element distance is only approximately 8.5 mm at a frequency of 18 GHz. Another difficulty is in connecting the antenna elements to an underlying lobe-shaping network or to underlying microwave units. In addition, there is the danger that electromagnetic resonances will arise in the antenna elements. These resonances can considerably impair the electrical characteristics of the antenna elements.

The object of the present invention is to achieve a group antenna and antenna elements that do not have the above disadvantages of known broadband group antennas. The object of the invention is achieved by means of a group antenna characterized in that each antenna element comprises a rotationally-symmetrical body arranged on an earth plane that is common to several antenna elements, with the axis of rotation of the body essentially perpendicular to the earth plane, which body, at the end furthest away from the earth plane, is shaped so that it tapers inwards with increasing distance from the earth plane and is provided with a metallic casing surface. Antenna elements suitable for incorporation in the group antenna are characterized in that the rotationally-symmetrical body is provided with a metallic casing surface.

By means of the invention, a group antenna and antenna elements are achieved that are simple and cheap to produce. The installation of the antenna elements is simple and the adjacent antenna elements do not need to be welded together. The antenna elements consist of metal. In this way, the problems are avoided that are associated with dielectric substrates that are normally used in group antennas. Problems that are associated with dielectric substrates include losses, surface waves and resonances.

According to an advantageous embodiment, the earth plane of the group antenna is provided with recesses in the forms of slots that separate the antenna elements from each other and function electrically as open circuits. By means of the introduction of these slots in the earth plane, separation of the antenna elements has been achieved in a simple way, while at the same time the production of the slots only requires simple manufacturing technology and can be carried out, for example, by milling.

According to another advantageous embodiment of the group antenna according to the invention, the antenna elements are connected to the earth plane by means of a connection that can be broken, such as a screw connection. The antenna elements are characterized in that the other end of the body comprises means for attaching the body in such a way that it can be removed, and the means for attaching the body in such a way that it can be removed comprise, according to one embodiment, one part of a screw connection. The embodiment allows the antenna elements to be removed easily, which facilitates the replacement of defective antenna elements. Instead of scrapping a whole module of antenna elements, in the most favourable cases it is sufficient to unscrew and replace a single antenna element. As a result of the antenna element's symmetrical shape, the installation is made easier, as the antenna element can be screwed on in any rotational position.

According to yet another advantageous embodiment, a spacing sleeve is incorporated in each antenna element at the transition between the rotationally-symmetrical body and the earth plane. The spacing sleeve is suitably provided with at least one cable bush with a first opening aligned in the radial direction of the spacing sleeve and a second opening aligned parallel with the axis of symmetry of the body and the sleeve. The incorporation of a spacing sleeve facilitates the attachment of the antenna elements to a lobe-shaping network or microwave units lying under the earth plane. At the same time as the rotationally-symmetrical body of the antenna element is installed on the earth plane by means of a rotational movement, the cables incorporated and the spacing sleeve can be held fixed relative to the earth plane.

According to yet another advantageous embodiment, the earth plane is provided with two cable bushes for each antenna element, which are each allocated a double-conductor, for example a coaxial cable, one conductor of which is attached to the antenna element and the other conductor of which is attached to an adjacent antenna element. The arrangement of cable bushes and the method of attaching the cables gives the group antenna a logical construction and contributes to the simple attachment of the antenna to a feeder unit, such as a number of microwave units. The antenna according to the invention makes possible a close connection to microwave units and, according to an embodiment, the feeder unit comprises one or more microwave units that form the antenna elements' common earth plane. By this means, power losses that arise in coaxial contacts and connection contacts are reduced, while at the same time the costs of coaxial contacts and coaxial cables disappear or are considerably reduced. In addition, a close connection to the microwave units saves space.

The antenna elements can be placed in a number of different grid configurations. Two attractive grid configurations in this connection can be the rectangular grid or the triangular grid.

According to a suitable dimensioning of the group antenna, two adjacent antenna elements are arranged with a distance between centres of essentially half a wavelength for the highest working frequency of the group antenna. This gives the group antenna an optimal compact form without making the antenna more complex in its design.

The rotationally-symmetrical body of the antenna element can be given a number of different forms, such as for example a circular paraboloid or a conical shape.

According to one embodiment, the rotationally-symmetrical body of the antenna element consists principally of aluminium. The choice of aluminium as conductor gives the antenna element a low weight. Another embodiment of the antenna element according to the invention that keeps down the weight is to make the rotationally-symmetrical body hollow.

A stable and easily manufactured antenna element according to the invention is characterized in that the rotationally-symmetrical body consists of an homogenous metallic material. The antenna element can be manufactured by turning and the homogeneity contributes to the stability of the antenna element.

A group antenna according to the invention can be constructed of antenna modules, with each module comprising a plurality of antenna elements.

The invention will be described below with reference to the attached drawings in which:

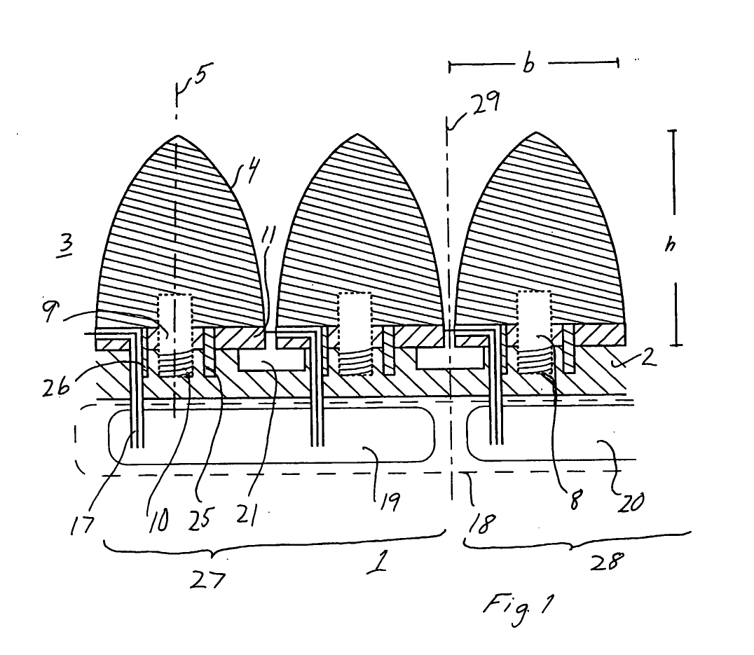

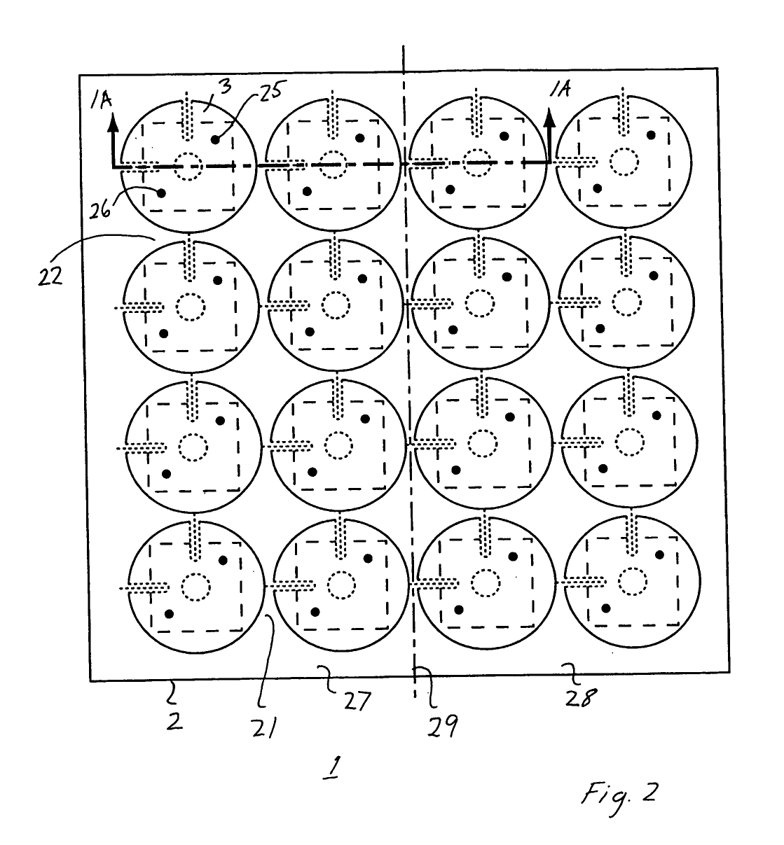

FIG. 1 shows schematically according to the section 1A-1A in FIG. 2 a sectioned side view of a part of a group antenna according to an embodiment.

FIG. 2 shows a schematic top view of an embodiment of a group antenna according to the invention.

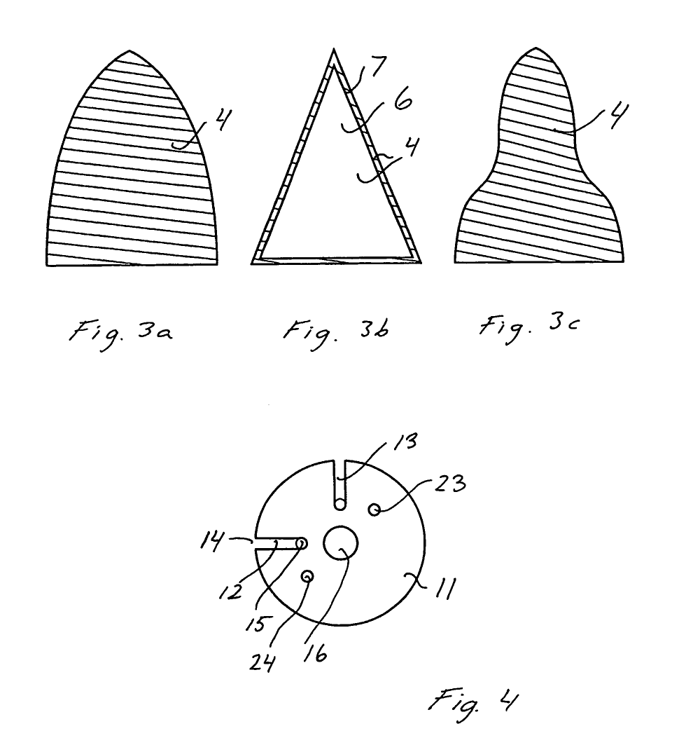

FIGS. 3a-3c show in section through the centre of rotation three different examples of embodiments of a rotationally-symmetrical body comprised in an antenna element according to the invention.

FIG. 4 shows in top view an example of a spacing sleeve that can be incorporated in the antenna element according to the invention.

The group antenna 1 shown in FIGS. 1 and 2 comprises an earth plane or an earth plate 2 on which the antenna elements 3 are arranged. The antenna elements comprise a rotationally-symmetrical body 4 with an axis of symmetry 5. The ratio between the height h and the breadth b of an incorporated antenna element can vary, but lies preferably within a range between the ratio 1:1 and the ratio 6:1.

FIG. 3 shows three examples of how the symmetrical body can be designed. The body shown in FIG. 3a is a circular paraboloid and is constructed of homogenous metallic material. The body according to FIG. 3b is a hollow conical shape with a cavity 6 surrounded by a metallic casing 7. A third more varied shape is shown in FIG. 3c. The body is shown here homogeneous, but can also be constructed with a cavity. In a more extreme embodiment, the body can even be shaped so that it does not taper continuously, but can have a flaring midsection. The metallic material can consist of aluminium, stainless steel or other suitable conductive metallic material. The symmetrical bodies of the antenna elements covered with metallic material constitute the radiating elements of the antenna.

As shown best in FIG. 1, a screw connection 8 is arranged to connect the rotationally-symmetrical body 4 to the earth plane 2. In the example shown, the screw connection consists of a projecting threaded pin 9 permanently attached to the rotationally-symmetrical body or alternatively constructed in one piece with the body. The threaded pin 9 engages with a threaded hole 10 formed in the earth plane 2. A spacing sleeve 11, see FIG. 4, is arranged between the rotationally-symmetrical body 4 and the earth plane 2. The spacing sleeve 11 is provided with two cable bushes 12 and 13 with an opening 14 in the radial direction of the spacing sleeve and an opening 15 in the axial direction. In the centre of the spacing sleeve, there is a hole 16 dimensioned to take the pin 9. In addition to the hole 16, the spacing sleeve is provided with two further holes 23, 24 to engage with pins 25, 26 projecting from the earth plane 2.

For installing an antenna element, the spacing sleeve 11 is put in place centrally over the threaded hole 10. In addition, the requisite cables 17 are put in place. Thereafter, the rotationally-symmetrical body 4 with the threaded pin 9 is screwed tight onto the earth plane 2 with the spacing sleeve between. The spacing sleeve 11 is held fixed relative to the earth plane 2 while the body 4 is screwed tight. At a suitable moment, the screwing movement is discontinued. As the body 4 is rotationally symmetrical, the rotational position of the body has no effect on the function of the antenna. In the embodiment shown here, the spacing sleeve 11 is fixed relative to the earth plane 2 by the interaction between the projecting pins 25, 26 on the earth plate and holes 23, 24 in the spacing sleeve 11. Other solutions are possible within the framework of the invention.

Slots 21, 22 are arranged in the earth plane 2. In combination, these slots form channels around each antenna element 3. In the example shown in FIG. 2, the channel network is constructed of five parallel slots 22 that are intersected at right angles by five parallel slots 21. The electrical function of the slots is to act as an open circuit.

As indicated by broken lines in FIG. 1, a feeder unit is arranged in association with the underside of the earth plane 2. The feeder unit has been given the reference numeral 18 and can consist of a plurality of microwave units 19, 20, each of which serves a plurality of antenna elements via cables 17. By arranging the microwave units directly in contact with the earth plane 2, the simplest possible connection of the antenna units 3 is obtained with short cable runs and few or no joints. It is also possible to design the feeder unit consisting of microwave units in such a way that the microwave units form the earth plane 2 of the group antenna.

The group antenna is suitable for modular construction and, in the embodiment described above, comprises two modules 27 and 28. A broken line 29 marks the interface between the modules 27 and 28. When the group antenna is constructed of adjacent modules in this way, with each module comprising a number of antenna elements 3, a joint is needed between adjacent modules. This joint is located suitably centrally in a slot, and in FIGS. 1 and 2 is located in one of the slots 21 according to the broken line 29. A location of the joint centrally in a slot is favourable as the electrical surface currents are weak at the bottom of the slot. By this means, no strong current paths are cut.

The invention is not limited to the embodiments described above as examples, but can be modified within the framework of the following patent claims.

1. An electrically controlled broadband group antenna comprising a plurality of antenna elements arranged in a common plane and connected to a feeder unit, wherein each antenna element comprises a rotationally-symmetrical body arranged on an earth plane that is common to several antenna elements, with the axis of rotation of the body essentially perpendicular to the earth plane, which body, at the end furthest away from the earth plane, is shaped so that it tapers inwards with increasing distance from the earth plane and is provided with a metallic casing surface.

2. The group antenna according to claim 1, wherein the earth plane is provided with recesses in the forms of slots that separate the antenna elements from each other and function electrically as open circuits.

3. The group antenna according to claim 1, wherein the antenna elements are connected to the earth plane by means of a connection that can be broken, such as a screw connection.

4. The group antenna according to claim 1, wherein a spacing sleeve is incorporated in each antenna element at the transition between the rotationally-symmetrical body and the earth plane.

5. The group antenna according to claim 1, wherein the earth plane is provided with two cable bushes for each antenna element, which are each allocated a double-conductor, for example a coaxial cable, one conductor of which is attached to the antenna element and the other conductor of which is attached to an adjacent antenna element.

6. The group antenna according to claim 1, wherein the antenna elements are placed in a rectangular grid.

7. The group antenna according to claim 1, wherein the antenna elements are placed in a triangular grid.

8. The group antenna according to claim 4, wherein the spacing sleeves comprise cable bushes.

9. The group antenna according to claim 1, wherein two adjacent antenna elements are arranged with a distance between centers of essentially half a wavelength for the highest working frequency of the group antenna.

10. The group antenna according to claim 1, wherein the feeder unit comprises one or more microwave units that form the antenna elements' common earth plane.

11. An antenna element suitable for incorporation in an electrically controlled broadband group antenna according to claim 1, the antenna element comprising a rotationally-symmetrical body tapering towards one end, wherein the rotationally-symmetrical body is provided with a metallic casing surface.

12. The antenna element according to claim 11, wherein the other end of the body comprises means for attaching the body in such a way that it can be removed.

13. The antenna element according to claim 12, wherein the means for attaching the body in such a way that it can be removed comprise one part of a screw connection.

14. The antenna element according to claim 11, wherein the rotationally-symmetrical body is essentially a conical shape.

15. The antenna element according to claim 11, wherein the rotationally-symmetrical body is essentially a circular paraboloid.

16. The antenna element according to claim 11, wherein the rotationally-symmetrical body consists principally of aluminum.

17. The antenna element according to claim 11, wherein the rotationally-symmetrical body is hollow.

18. The antenna element according to claim 11, wherein the rotationally-symmetrical body consists of an homogenous metallic material.

19. The antenna element according to claim 11, wherein a circular spacing sleeve is incorporated in association with the other end of the body.

20. The antenna element according to claim 19, wherein the spacing sleeve is provided with at least one cable bush with a first opening aligned in the radial direction of the spacing sleeve and a second opening aligned parallel with the axis of symmetry of the body and the sleeve.

21. An antenna module comprising a plurality of antenna elements according to claim 11.
